(19) United States
(12) Patent Application Publication
(10) Pub. No.: US 2006/0122295 A1
(43) Pub. Date: Jun. 8, 2006

(54) Stabilized polymer composition

(75) Inventors: Harry Oysaed, Stathelle (NO); Svein Jamtvedt, Stathelle (NO); Astrid E. Frohaug, Stathelle (NO)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Borealis Polymers Oy, Porvoo, FI (US)

(21) Appl. No.: 10/530,682

(22) PCT Filed: Oct. 8, 2002
(86) PCT No.: PCT/EP02/11258

§ 371 Date: Oct. 4, 2005

(51) Int. Cl. C08K 5/524

(52) U.S. Cl. 524/128

(57) ABSTRACT

The present invention relates to an antioxidant composition comprising (a) 0.01-0.5% by weight of sterically hindered phenolic compound, (b) 0.01-0.5% by weight of phosphorous compound, and (c) 0.01-1% by weight of sulphurcontaining compound. Said antioxidant composition reduces degradation of plastic materials during processing and end-use and thus, increases the long term thermal stability of those plastic materials. Moreover, this invention relates to methods for producing a final polymeric article with an increased long term thermal stability and stabilization against ageing by radical decomposition processes and polymeric intermediate materials as well as polymeric articles comprising the inventive antioxidant composition.

### TECHNICAL FIELD

The present invention relates to a stabilized polymer composition comprising a composition of antioxidants which reduces degradation of plastic materials during processing and end-use and thus, increases the long term thermal stability of those plastic materials. Moreover, this invention relates to methods for producing a final polymeric article with an increased long term thermal stability and stabilization against ageing by radical decomposition processes and polymeric intermediate materials as well as polymeric articles comprising the inventive antioxidant composition.

### BACKGROUND ART

Recent advances in the manufacturing and processing of plastic polymers have led to the application of plastics in virtually every aspect of modern day life. However, polymeric compounds are prone to ageing under the effects of light, oxygen and heat. This results in a loss of strength, stiffness and flexibility, discolouration and scratching and loss of gloss.

Polymeric compounds, for example polyolefines like polyethylene and polypropylene undergo radical driven degradation processes especially during processing steps which might include moulding, extrusion etc. However, degradation even proceeds during end-use by a radical mechanism under the influence of light, heat etc. and will finally destroy the polymer properties.

It is well-known in the art that antioxidants and light stabilizers can prevent or at least reduce these effects. Several types of additives are added to polymers to protect them during processing and to achieve the desired end-use properties. Additives are generally divided in stabilizers and modifiers. Typical modifiers are antistatic- and anti-fogging agents, acid scavengers, blowing agents, cling agents, lubricants and resins, nucleating agents, slip- and anti-blocking agents as well as fillers, flame retardants, compatibilizers and crosslinkers.

Antioxidants traditionally and currently used comprise hindered phenolics, aromatic amines, organo-phosphites/phosphonites and thioethers. Neutralizers are often used to boost performance and diminish effects of residual polymer acidity.

Because of its sensitivity to oxidation, stabilization of polypropylene polymers against thermal oxidation is extremely important. Polypropylene polymers are probably the polymer most studied in this respect. At elevated temperatures and with excess of air, polypropylene polymers disintegrate to powdery oxidation products. This process is characterized by relatively well-defined and reproducible induction periods, commonly called oven lifetimes. Endpoints are easily detected even visually. The disintegration begins mostly at the etches and corners of the test species. It is often accompanied by yellow to brown discoloration.

An important aspect of process stabilization is that the degradation reaction products produced during processing can accelerate other types of a degradation later in the polymer life time, e.g. impede the light stability of the polymer.

For this reason, effective processing stability is essential in the production of durable plastic and articles.

Long term heat stability (LTHS) is an important property for many applications of polymers, especially polyolefines. Generally, long term thermal stability requirements are met by adding high concentrations of phenol antioxidants or combinations of phenols and thioethers to the polymer. Problems with such systems may be that tendency to yellowing increased by increased phenol concentrations or that the thioether may influence organoleptic properties in a negative way.

There are several approaches known in the prior art which address the problem of stabilization of polymers against radical decomposition which among others finally results in a loss of long term thermal stability of a polymer.

For example, U.S. Pat. No. 6,015,854 teaches propylene-ethylene copolymers of high clarity and therefore incorporates clarifying agents into the copolymer mixture, however, the compositions disclosed therein may also contain stabilizers, antioxidants, lubricants, acid acceptors, synergists, anti-static agents, nucleating agents and additives which stabilize against radiation. To improve long term thermal stability, primary antioxidants of phenolic-type were added. Furthermore, it is stated that second type antioxidants like phosphites or hindered amines provide for an improved stability in melt flow and colour during the melt processing of the plastic material. The functions of all other primary and secondary antioxidants mentioned in the reference are well-known in the art. It is also disclosed that the synergistic enhance of the primary antioxidants can be achieved by including thioethers. However, this reference focuses on clarity of the plastic material and consequently none of the properties measured in the examples is related to long term heat stability.

U.S. Pat. No. 6,022,946 is directed to a method of deactivating catalyst residue in a polyolefin in a post-reactor vessel containing carbon monoxide. Claim 1 mentions the incorporation of an acid acceptor and at least one secondary antioxidant into the deactivated polyolefin polymer. This secondary antioxidant may be an organic phosphite. Primary antioxidants including phenolic types are also mentioned with the main function to provide long term thermal stability. The synergistic enhance of this performance by including thioethers is also noted. Secondary antioxidants including phosphites are mentioned which provide for improved colour and reduced melt flow breaking tendency. Again, this reference does not teach anything going beyond the general knowledge in the art according to which long term thermal stability can be controlled by the addition of a primary antioxidant and optionally a synergistic thio-compound.

Though U.S. Pat, No. 6,197,886 relates to polypropylene impact copolymers having improved mechanical properties, similar comments can be provided again. There are polymeric compositions disclosed which may contain antioxidants. Primary antioxidants, including phenolic types are mentioned with the main function to provide long term heat stability. The synergistic enhance of this performance by including thioethers is also mentioned. Furthermore, addition of secondary antioxidants including phosphites with the focus on the improvement of the melt processing are disclosed as well. However, nothing can be taken from that reference which would enable the skilled artisan to achieve an improved long term thermal stability exceeding those already known in the art.

Furthermore, U.S. Pat. No. 6,090,877 relates to a low smoke forming, acid neutralized propylene polymer composition comprising a propylene and an acid scavenging amount of mono potassium citrate. Phenolics and phosphites are mentioned as possible antioxidants for polypropylene together with potassium citrate as an acid scavenger but this reference is quiet with regard to long term thermal stability of the propylene polymer compositions.

Another prior art reference (Zweifel, H., Stabilization of Polymeric Materials, Springer-Verlag, 1998, p. 76) reflects the general and well-established view in the art on the best mode to control long term thermal stability in polymers:

“In contrast to stabilization during processing, the presence of phosphites had not significant influence on long term thermal ageing of polyolefines”.

Likewise, Schwartzenbach et al., in Zweifel's, Plastic Additives Handbook, 5th edition, Hanser Publishers, 2001, p. 53 states:

“Phosphites do not contribute to long term thermal stability themselves. Long term thermal stability is only protected by the available phenol concentration. To improve long term thermal stability, thiosynergists as hydroperoxide decomposers in combination with a phenol are recommended.”

Though, the necessary level of long term stability of a specific plastic material very much depends on the intended technical application thereof, there still exists a continued need for an improved control of this polymer property during processing steps and end use of the polymer. As discussed above, the prior art teaching suggests to apply an antioxidant composition of a phenolic compound and a thiosynergist for hydroperoxide decomposition to the polymeric base material to reduce long term thermal ageing.

Therefore, the major focus to increase long term thermal stability of a polymer relied so far in the provision of improved phenolic-type and thioether antioxidants. That is to say, specific antioxidant compounds were developed which provide for example for a low volatility, high melting point, hydrolytic and thermal stability as well as the absence of unwanted side effects like having a colouring effect or an unclean toxicological profile which could jeopardize FDA and/or EU-SCF approvals. Most of those properties of the state of the art antioxidants are met by the unique structural features of these compounds, for example bulky residues of tert.-butyl substituted phenyl residues which provide for sterical hindrance to lower volatility in combination with a high molecular weight of those compounds.

In the state of art, the most obvious way to further increase long term thermal stability is generally seen in the use of higher amounts of those antioxidants. However, it is likewise obvious that simply increasing the antioxidant concentration in the polymer composition will most likely affect the properties of the final plastic material in a negative way. Therefore, it is highly desirable to be able to reduce long term thermal ageing with even less antioxidant compounds used in the polymer composition.

### DESCRIPTION IF THE INVENTION

The inventors of the present application have addressed this issue by a different approach than those described above in the prior art. The underlying problem of this invention is to be seen in the provision of polymers comprising specific antioxidant compositions which already allow to improve long term thermal stability of said polymeric material at very low concentrations of antioxidant compounds. Moreover, at the same time this stability towards thermal ageing should be further increased in view of long term thermal stabilities achieved so far by prior art approaches. Furthermore, such a composition of antioxidants should provide for a highly effective and versatile stabilization which is useful in a wide variety of applications. Likewise, this composition should be characterized by its superior thermal stability and low volatility, excellent atmospheric and in-polymer hydrolytic stability, outstanding protection against discoloration and degradation during processing, and excellent protection against long term polymer degradation.

In accordance with this objective, and other objectives that will be readily apparent to those skilled in the art upon reading this disclosure, it was surprisingly found that the specific combination of a phenolic compound together with a phosphite and a sulphur-containing compound substantially increase the long term heat stability of a polymer at unexpected low concentrations.

In accordance with the invention, it is provided a stabilized polymer composition comprising a polymer and an antioxidant composition for improving the long term heat stability of polymers, in particular polyolefins, said polymer composition comprising:
(a) 0.01%-0.5% by weight of at least one sterically hindered phenolic compound, wherein said phenolic compound contains at least one phenolic moiety of general formula (I):
   [HO—(R₁R₂R₃R₄Phenyl)-] (I)

wherein R₁, R₂, R₃ or R₄ may be the same or different and at least one of R₁, R₂, R₃ or R₄ is selected from the group consisting of branched alkyl having 1 to 12 carbon atoms, preferably tert.-butyl, iso-propyl, cyclohexyl, cyclopentyl and adamantyl, the others of R₁, R₂, R₃ or R₄ being H or lower alkyl having 1 to 6 carbon atoms;
(b) 0.01%-0.5% by weight of at least one phosphorous compound, wherein said phosphorous compound contains at least one phosphorous compound moiety of general formula (II):
   PX₁X₂X₃ (II)

wherein X₁ may be R₅ or OR₅, X₂ may be R₆ or OR₆, X₃ may be R₇ or OR₇ and R₅, R₆ or R₇ may be the same or different and at least one of R₅, R₆ or R₇ is selected from the group consisting of C₁-C₂₅ alkyl group, aryl group or aralkyl group which may be substituted by lower alkyl having 1 to 6 carbon atoms, or two or any of R₅, R₆ or R₇ may form a ring structure having 4 to 12 carbon atoms,
(c) 0.01%-1% by weight of at least one sulphur-containing compound of general formula (III):
   R₈—(S)ₓ—R₉ (III)

wherein x=1 or 2, and wherein R₈ and R₉ may be the same or different and are selected from the group consisting of C₁₀-C₂₅ alkyl groups optionally being substituted with C₁-C₁₂ alkyl ester carboxylates,

wherein said % by weight values are referred to the polymer composition.

In a preferred embodiment, the stabilized polymer composition comprises a polyolefin and an antioxidant composition, wherein said antioxidant composition comprises:
(a) 0.02%-0.2% by weight of said at least one sterically hindered phenolic compound,
(b) 0.03%-0.2% by weight of said at least one phosphorous compound, and
(c) 0.05%-0.6% by weight of said at least one sulphur-containing compound of general formula (III),

wherein said % by weight values are referred to the polymer composition.

In a further preferred embodiment, the stabilized polymer composition comprises a polyolefin and an antioxidant composition, wherein said antioxidant composition comprises:
(a) 0.03%-0.15% by weight of said at least one sterically hindered phenolic compound,
(b) 0.05%-0.15% by weight of said at least one phosphorous compound, and
(c) 0.1%-0.5% by weight of said at least one sulphur-containing compound of general formula (III),

wherein said % by weight values are referred to the polymer composition.

When using the inventive antioxidant composition, further compounds selected from additives, fillers, minerals and lubricants can be compounded to the polyolefin for improving the processability and surface characteristics thereof.

The phenolic compound contains preferably at least one phenolic moiety of general formula (Ia):
HO—(R₁R₂R₃R₄Phenyl)-W (Ia)

wherein R₁ and R₄ being in the 2- and 6-position of the phenol residue may be the same or different and are selected from the group consisting of preferably branched C₁ to C₁₂ alkyl, particularly tert.-butyl, iso-propyl, cyclohexyl, cyclopentyl and adamantyl residues, R₂ and R₃ having the meaning as given before, and W is selected from C₁ to C₁₂ alkyl, C₁ to C₁₂ alkoxy, C₁ to C₁₂ alkyl carboxylate or C₁ to C₁₂ alkyl substituted by a further group of the formula HO—(R₁R₂R₃R₄Phenyl)-, wherein R₁ to R₄ have the meaning as indicated before.

In accordance with the present invention, it is particularly preferred that at least one of the following phenolic-type antioxidant compounds is comprised by the inventive antioxidant compositions. These are the sterically hindered phenolic compounds:
2,6-Di-tert.-butyl-4-methyl phenol;
Pentaerythrityl-tetrakis(3-(3′,5′-di-tert.-butyl-4-hydroxyphenyl)-propionate;
Octadecyl 3-(3′,5′-di-tert.-butyl-4-hydroxyphenyl)propionate;
1,3,5-Trimethyl-2,4,6-tris-(3,5-di-tert.-butyl-4-hydroxyphenyl)benzene;
2,2′-Thiodiethylene-bis-(3,5-di-tert.-butyl-4-hydroxyphenyl)-propionate;
Calcium-(3,5-di-tert.-butyl-4-hydroxy benzyl monoethyl-phosphonate);
1,3,5-Tris(3′,5′-di-tert.-butyl-4′-hydroxybenzyl)-isocyanurate;
Bis-(3,3-bis-(4′-hydroxy-3′-tert.-butylphenyl)butanoic acid)-glycolester;
4,4′-Thiobis(2-tert.-butyl-5-methylphenol);
2,2′-Methylene-bis(6-(1-methyl-cyclohexyl)para-cresol);
N,N′-hexamethylene bis(3,5-di-tert. Butyl-4-hydroxy-hydrocinnamamide;
2,5,7,8-Tetramethyl-2(4′,8′,12′-trimethyltridecyl)chroman-6-ol;
2,2′-Ethylidenebis(4,6-di-tert.-butylphenol);
1,1,3-Tris(2-methyl-4-hydrosy-5-tert.-butylphenyl)butane;
1,3,5-Tris(4-tert.-butyl-3-hydroxy-2,6-dimethylbenzyl)-1,3,5-triazine-2,4,6-(1H,3H,5H)-trione;
3,9-Bis(1,1-dimethyl-2-(beta-(3-tert.-butyl-4-hydroxy-5-methylphenyl)propionyloxy)ethyl)-2,4,8,10-tetraoxaspiro(5,5) undecane;
1,6-Hexanediyl-bis(3,5-bis(1,1-dimethylethyl)-4-hydroxybenzene-propanoate);
2,6-Di-tert.-butyl-4-nonylphenol;
3,5-Di-tert.-butyl-4-hydroxyhydrocinnamic acid triester with 1,3,5-tris(2-hydroxyethyl)-s-triazine-2,4,6(1H,3H,5H)-trione;
4,4′-Butylidenebis(6-tert.Butyl-3-methylphenol);
2,2′-Methylene bis(4-methyl-6-tert.-butylphenol);
2,2-Bis(4-(2-(3,5-di-t-butyl-4-hydroxyhydrocinnamoyloxy))ethoxyphenyl))propane;
Triethyleneglycole-bis-(3-tert.-butyl-4-hydroxy-5methylphenyl)propionate;
Benzenepropanoic acid, 3,5-bis(1,1-dimethylethyl)-4-hydroxy-, C₁₃-C₁₅-branched and linear alkyl esters;
6,6′-Di-tert.-butyl-2,2′-thiodi-p-cresol;
Diethyl((3,5-bis(1,1-dimethylethyl)-4-hydroxyphenyl)methyl)phosphonate;
4,6-Bis(octylthiomethyl)o-cresol;
Benzenepropanoic acid, 3,5-bis(1,1-dimethylethyl)4-hydroxy-, C₇-C₉-branched and linear alkyl esters;
1,1,3-Tris[2-methyl-4-[3-(3,5-di-t-butyl-4-hydroxyphenyl)propionyloxy]-5-t-butylphenyl] butane; and
a butylated reaction product of p-cresol and dicyclopentadiene.

Among those compounds, the following phenolic-type antioxidant compounds are especially preferred to be included in the antioxidant composition according to the present invention:
Pentaerythrityl-tetrakis(3-(3′,5′-di-tert.-butyl-4-hydroxypheyl)-propionate;
Octadecyl 3-(3′,5′-di-tert.-butyl-4-hydroxyphenyl)propionate;
1,3,5-Trimethyl-2,4,6-tris-(3,5-di-tert.-butyl-4-hydroxyphenyl)benzene;
1,3,5-Tris(3′,5′-di-tert.-butyl-4′-hydroxybenzyl)-isocyanurate.
Bis-(3,3-bis-(4′-hydroxy-3′-tert.-butylphenyl)butanoic acid)-glycolester; and
3,9-Bis(1,1-dimethyl-2-(beta-(3-tert.-butyl-4-hydroxy-5-methylphenyl)propionyloxy)ethyl)-2,4,8,10-tetraoxaspiro(5,5)undecane;

Furthermore, it is preferred that the phosphorous compound of the inventive antioxidant compositions contains a phosphite moiety of general formula bis(R₁₀)-pentaerythritol-diphosphite, wherein R₁₀ is selected from C₁-C₂₅ alkyl group or aryl group which may be substituted by lower alkyl having 1 to 6 carbon atoms.

In accordance with the present invention, it is also preferred that at least one of the following phosphorous-type antioxidant compounds is comprised by the inventive antioxidant compositions. These are the phosphorous compounds:
Tris(2,4-di-t-butylphenyl)phosphite;
Tetrakis-(2,4-di-t-butylphenyl)-4,4′-biphenylen-di-phosphonite
Bis(2,4-di-t-butylphenyl)-pentaerythrityl-di-phosphite;
Di-stearyl-pentaerythrityl-di-phosphite;
Tris-nonylphenyl phosphite;
Bis(2,6-di-t-butyl-4-methylphenyl)pentaerythrityl-di-phosphite;
2,2′-Methylenebis(4,6-di-t-butylphenyl)octyl-phosphite;
1,1,3-Tris(2-methyl-4-ditridecyl phosphite-5-t-butylphenyl)butane;
4,4′-Butylidenebis(3-methyl-6-t-butylphenyl-di-tridecyl)phosphite;
Bis(2,4-dicumylphenyl)pentaerythritol diphosphite;
Bis(2-methyl-4,6-bis(1,1-dimethylethyl)phenyl)phosphorous acid ethylester;
2,2′,2″-Nitrilo triethyl-tris(3,3′5,5′-tetra-t-butyl-1,1′-biphenyl-2,2′-diyl)phosphite);
Phosphorous acid, cyclic butylethyl propandiol, 2,4,6-tri-t-butylphenyl ester;
Bis(2,4,6-tri-t-butylphenyl)-pentaerythrityl-di-phosphite;
2,2′-Ethylidenebis(4,6-di-t-butylphenyl)fluorophosphonite
6-(3-tert-Butyl-4-hydroxy-5-methylphenyl)propoxy)-2,4,8,10-tetra-tert.butyldibenz(d,t)(1.3.2)dioxaphosphepin; and
Tetrakis-(2,4-di-t-butyl-5-methyl-phenyl)-4,4′-biphenylen-di-phosphonite

Among those compounds, the following phosphite/phosphonite-type antioxidant compounds are especially preferred to be included in an antioxidant composition according to the present invention:
Tetrakis-(2,4-di-t-butylphenyl)-4,4′-biphenylen-di-phosphonite;
Bis(2,6-di-t-butyl-.4-methylphenyl)pentaerythrityl-di-phosphite;
Di-stearyl-pentaerythrityl-di-phosphite; and
Bis(2,4-dicumylphenyl)pentaerythritol diphosphite.

In accordance with the present invention, the sulphur-containing compound of general formula (III):
R_{8—(S)}_{x—R}₉ (III)

is selected from Di(C₁-C₂₀)alkyl-(S)ₓ-di-carboxylate wherein the carboxylic acid is selected from C₁ to C₁₀ alkyl carboxylic acids. Some of those preferred compounds are exemplified as follows:
Di-stearyl-thio-di-propionate;
Di-palmityl/stearyl-thio-di-propionate;
Di-lauryl-thio-di-propionate;
Di-tridecyl-thio-di-propionate;
Di-myristyl-thio-di-propionate;
Pentaerythritol octyl thiodipropionate;
Lauryl-stearyl-thio-di-propionate;
Di-octadecyl-disulphide;
Di-tert-dodecyl-disulphide; and
Pentaerythritol-tetrakis-(3-laurylthiopropionate);
wherein Di-stearyl-thio-di-propionate and Di-tert-dodecyl-disulphide are especially preferred.

In a particularly preferred embodiment, the inventive antioxidant composition is such that it comprises a mixture of, as the sterically hindered phenolic compound, 1,3,5-Tris(4-tert.-butyl-3-hydroxy-2,6-dimethylbenzyl)-1,3,5-triazine-2,4,6-(1H,3H,5H)-trione or Pentaerythrityl-tetrakis(3-(3′,5′-di-tert.-Butyl-4-hydroxyphenyl)-propionate, as the phosphite compound, bis(2,4-dicumylphenyl)pentaerythritol diphosphite; and, as the sulphur-containing compound, di-stearyl-thio-di-propionate. Moreover, the inventive antioxidant composition may optionally further comprise metal deactivators and/or UV-stabilisers, wherein preferably said UV-stabilizers are sterically hindered amines.

It is another object of the present invention to provide a polymeric material which comprises the above-described antioxidant composition and at least one polymer selected from the group consisting of polyolefines, polyethers, polyimides, polyamides and polyesters. If said at least one polymer comprises a polyolefin, it is preferred that the polyolefin polymer is a homo-or co-polymer of polyethylene, polypropylene and polybutadiene.

In accordance with a further object, the present invention, provided for the use of the above-described antioxidant composition to reduce degradation of a polymeric material by radical mechanisms during processing and end use of said polymeric material and preferably to increase the long term thermal stability of the polymeric material.

In yet another object of the present invention, there is provided a method for producing a final polymeric article with an increased long term thermal stability against ageing by radical degradation processes comprising the steps of:
(a) providing an unstabilised base polymer material;
(b) adding to said base polymer material the inventive antioxidant composition;
(c) converting the composition obtained in step (b) in a melt-forming process; and
(d) confectioning the polymeric material obtained in step (c).

This method may optionally include the further step concerning the addition of other stabilisers and/or modifiers before the converting step.

The converting step typically includes injection moulding, blow moulding, rotational moulding and/or extrusion and the confectioning step generally comprises cutting, lamination and/or welding.

Furthermore, it is still another object of the present invention to provide a polymeric article having a long term ageing stability and being obtainable by one of the above-described methods for producing a final polymeric article.

### EXAMPLES

In each of the following formulations of antioxidant compositions, the thioether Di-stearyl-thio-di-propionate was used as the sulphur-containing compound (c) at a concentration of 3000 ppm. Furthermore, a polypropylene homopolymer in form of an unstabilised powder was selected to verify the effect of the inventive antioxidant compositions on long term thermal stabilization. Beside the inventive antioxidant compositions, only 600 ppm Ca-stearate and partly 2000 ppm talc were further included into the polymer mixture as non-antioxidant additives where indicated.

The compounding steps were carried out for each formulation in a Prism extruder at the extruder condition of 210° C., 1 bar N_{2.}

Base Polymer:

PP-homopolymer unstabilised powder mfr (230° C./2.16 kg) 3 g/10 min.

Non-antioxidant Additives:

Ca-stearate (Calcium stearate SP, Faci, NO1,), talc (Tital 10, Incemin AG, NO2,)

Antioxidant Additives:

(a) Phenolic-type compound (I)
Pentaerythrityl-tetrakis(3-(3′,5′-di-tert.-butyl-4-hydroxyphenyl)-propionate (Irganox 1010™, Ciba Specialty Chemicals, AO-I-1),
1,3,5-Tris(4-tert.-butyl-3-hydroxy-2,6-dimethylbenzyl)-1,3,5-triazine-2,4,6-(1H,3H,5H)-trione (Cyanox 1790™, Cytec, Inc., AO-I-2),

(b) Phosphite-type compound (II)
Tris(2,4-di-t-butylphenyl)phosphite (Irgafos 168™, Ciba Specialty Chemicals, AO-II-1),
Bis(2,4-dicumylphenyl)pentaerythritol diphosphite (Doverphos S-9228™, Dover Chemical Corp., AO-II-2)

(c) Sulphur-containing compound (III)
Di stearyl-thio-di-propionate (Irganox PS-802, Ciba Specialty Chemicals, AO-III)

Table 1 provides an overview of the concentration of each antioxidant and non-antioxidant additive which are incorporated into the polypropylene homopolymer compositions of Examples 1-10.

After prism extrusion, MFR and YI were determined for each sample. With regard to Examples of Ref. Nos. 1,3 and 7-10 multiple extrusion at a Brabender extruder were carried out.

Long term heat stability was determined for each sample on pellets at 150° C. When degraded pellets were observed for the first time the YI value was then measured.

All results of these determinations are summarized in Table 2.

TABLE 1

| | Antioxidant additives | | | | | | | |
|---|---|---|---|---|---|---|---|---|
| | | | | | | Sulphur- | | |
| | | | | | | containing | Non-antioxidant | |
| Ref. | Phenolic type AO | | | Phosphite-type AO | | AO | additives | |
| No. | AO-I-1 | AO-I-2 | AO-I-3 | AO-II-1 | AO-II-2 | AO-III | NO1 | NO2 |
| 1 | 1200 ppm | — | — | 2400 ppm | — | 3000 ppm | 600 ppm | 2000 ppm |
| 2 | 1200 ppm | — | — | — | 1600 ppm | 3000 ppm | 600 ppm | 2000 ppm |
| 3 | 1200 ppm | — | — | — | 800 ppm | 3000 ppm | 600 ppm | 2000 ppm |
| 4 | — | 600 ppm | — | 1600 ppm | — | 3000 ppm | 600 ppm | 2000 ppm |
| 5 | — | 300 ppm | — | 1600 ppm | — | 3000 ppm | 600 ppm | 2000 ppm |
| 6 | — | 600 ppm | — | — | 800 ppm | 3000 ppm | 600 ppm | 2000 ppm |
| 7 | — | 300 ppm | — | — | 800 ppm | 3000 ppm | 600 ppm | 2000 ppm |
| 8 | 1200 ppm | — | — | 2400 ppm | — | 3000 ppm | 600 ppm | — |
| 9 | 1200 ppm | — | — | — | 800 ppm | 3000 ppm | 600 ppm | — |
| 10 | — | 300 ppm | — | — | 800 ppm | 3000 ppm | 600 ppm | — |

TABLE 2

| | | | | | | | | | long term heat | |
|---|---|---|---|---|---|---|---|---|---|---|
| | mfr after | | | | YI after | | | | stability | |
| Ref. | multiple extrusion | | | | multiple extrusion | | | | hours to | YI after |
| No. | 0. | 1. | 3. | 5. | 0. | 1. | 3. | 5. | degrad. | degrad. |
| 1 | 3.1 | 3.3 | 3.7 | 3.8 | −1.4 | −1.6 | 0 | 1.3 | 2620 | 43 |
| 2 | 3.0 | — | — | — | −1.5 | — | — | — | 3070 | 46 |
| 3 | 3.0 | 3.2 | 3.5 | 3.7 | −1.6 | −1.1 | 1.7 | 3.4 | 3020 | 47 |
| 4 | 2.9 | — | — | — | −0.8 | — | — | — | 2500 | 47 |
| 5 | 3.0 | — | — | — | −1.7 | — | — | — | 2280 | 35 |
| 6 | 3.0 | — | — | — | −1.0 | — | — | — | 3070 | 47 |
| 7 | 3.0 | 3.2 | 3.6 | 3.9 | −1.7 | −0.9 | 1.7 | 3 | 3020 | 36 |
| 8 | 3.0 | 3.2 | 3.6 | 3.7 | −1.9 | −1.6 | −1.1 | 0.4 | 2620 | 42 |
| 9 | 3.0 | 3.2 | 3.5 | 3.9 | −2.2 | −2.0 | −0.8 | 0.3 | 3020 | 47 |
| 10 | 3.0 | 3.2 | 3.8 | 4.3 | −2.4 | −1.6 | −0.6 | 0.2 | 3120 | 38 |

### Effect of Bis(2,4-dicumylphenyl)pentaerythritol diphosphite on Process Stability and LTHS

The equal mfr values after compounding (3.0+/−0.1) for all of the formulations show a very good process stabilising in each sample.

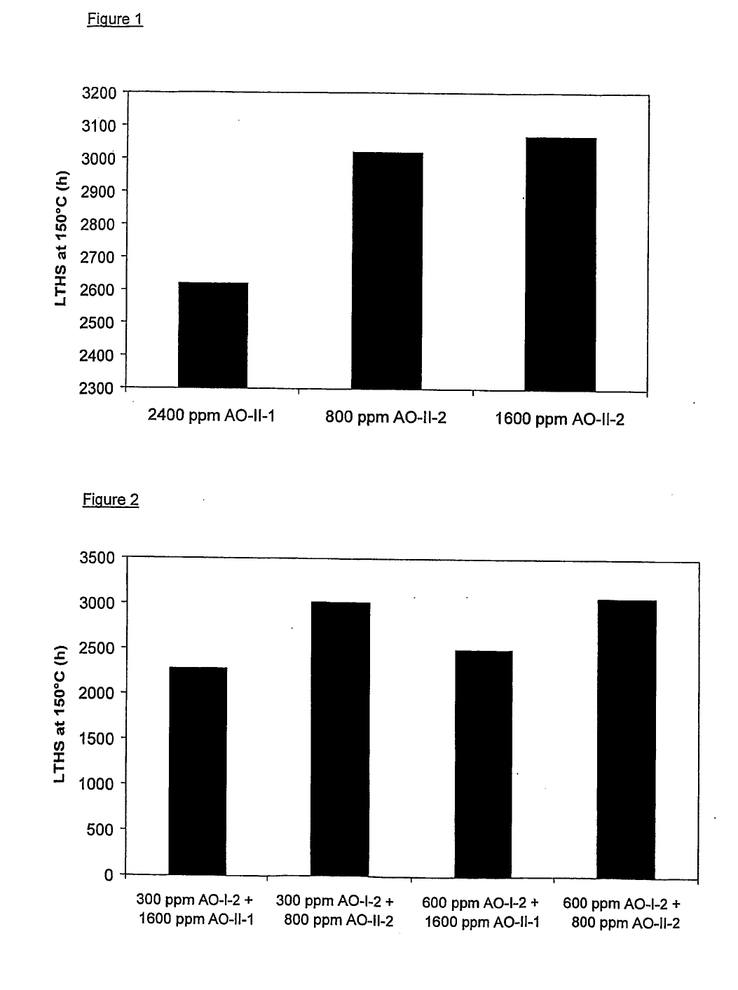

In the series of Ref. No. 1-3, Pentaerythrityl-tetrakis(3-(3′,5′-di-tert.-butyl-4-hydroxyphenyl)-propionate (Irganox 1010™, AO-I-1) is constant, and 2400 ppm Tris(2,4-di-t-butylphenyl)phosphite (Irgafos 168™, AO-II-1) is compared with 1600 ppm and 800 ppm of Bis(2,4-dicumylphenyl)-pentaerythritol diphosphite (Doverphos S-9228™)(AO-II-2). The results of mfr and YI after multiple extrusions are similar, though a little stronger yellowing effect was observed after the 5th extrusion of the sample comprising 800 ppm Doverphos S-9228™ (AO-II-2). FIG. 1 shows a comparison of LTHS values (hours at 150° C. before start of degradation) for the formulations with 1200 ppm Irganox 1010™ (AO-I-1). It can be taken from these results that, in contrast to the generally acknowledged opinion in the prior art, the phosphite also influences LTHS. An increase of more than 400 hours at 150° by replacing 2400 ppm Irgafos 168™ (AO-II-1) with 800 ppm Doverphos S-9228™ (AO-II-2) is quite considerable. Doubling the amount of Doverphos S-9228™ (AO-II-2) only gives a slight increase in LTHS. This proves that a smaller amount of the preferred Doverphos S-9228 leads to improved LTHS properties of the polymer.

FIG. 2 reflects the corresponding results for samples comprising another phenolic-type antioxidant, i.e. 1,3,5-Tris(4-tert.-butyl-3-hydroxy-2,6-dimethylbenzyl)-1,3,5-triazine-2,4,6-(1H,3H,5H)-trione (Cyanox 1790™, AO-I-2).

These results show that, by doubling the concentration of Cyanox 1790™ (AO-I-2) from 300 ppm to 600 ppm, only a slight increase in LTHS was achieved for both Irgafos 168™ (AO-II-1) and Doverphos S-9228™ (AO-II-2), but by replacing 1600 ppm Irgafos 168™ (AO-II-1) with 800 ppm Doverphos S-9228™ (AO-II-2), the LTHS increased by more than 700 hours (1 month) at 150° C. This finding is surprising in view of the prior art and shows a synergistic effect for the compounds as used.

2000 ppm of the talc Tital 10™ (Incemin, Inc.) seems to have only a minor or no effect on both process stability and LTHA (Table 2). In this respect, it is to be noted that Tital 10™ is a very pure talc.

1. A stabilized polymer composition comprising a polyolefin and an antioxidant composition for improving the long term heat stability of polyolefins, said antioxidant composition comprising:
(a)0.01-0.5% by weight of at least one sterically hindered phenolic compound, wherein said phenolic compound contains at least one phenolic moiety of general formula (I):
[HO—(R₁R₂R₃R₄Phenyl)-] (I)
wherein R₁, R₂, R₃ or R₄ may be the same or different and at least one of R₁, R₂, R₃ or R₄ is selected from the group consisting of branched alkyl having 1 to 12 carbon atoms, the others of R₁, R₂, R₃ or R₄ being H or lower alkyl having 1 to 6 carbon atoms;
(b) 0.01-0.5% by weight of at least one phosphorous compound, wherein said phosphorous compound is selected from the group consisting of Tetrakis-(2,4-di-t-butylphenyl)-4,4′-biphenylen-di-phosphonite; Bis(2,6-di-t-butyl-4-methylphenyl)pentaerythrityl-di-phosphite; Di-stearyl-pentaerythrityl-di-phosphite; and Bis(2,4-dicumylphenyl)pentaerythritol diphosphite;
(c) 0.01-1.0% by weight of at least one sulphur containing compound of general formula (III):
R₈—(S)ₓ—R₉ (III)
wherein x=1 or 2, and wherein R₈ and R₉ may be the same or different and are selected from the group consisting of C₁₀-C₂₅ alkyl groups,
wherein said % by weight values are referred to the polymer composition.

2. A stabilized polymer composition according to claim 1, comprising a polyolefin and an antioxidant composition, wherein said antioxidant composition comprises:
(a) 0.02%-0.2% by weight of said at least one sterically hindered phenolic compound,
(b) 0.03%-0.2% by weight of said at least one phosphorous compound, and
(c) 0.05%-0.6% by weight of said at least one sulphur containing compound of general formula (III),
wherein said % by weight values are referred to the polymer composition.

3. A stabilized polymer composition according to claim 1, comprising a polyolefin and an antioxidant composition, wherein said antioxidant composition comprises:
(a) 0.03%-0.15% by weight of said at least one sterically hindered phenolic compound;
(b) 0.05%-0.15% by weight of said at least one phosphorous compound, and
(c) 0.1%-0.5% by weight of said at least one sulphur containing compound of general formula (III),
wherein said % by weight values are referred to the polymer composition.

4. The stabilized polymer composition of claim 1, wherein the phenolic compound contains at least one phenolic moiety of general formula (Ia):
HO—(R₁R₂R₃R₄Phenyl)-W (Ia)
wherein R₁ and R₄ being in the 2- and 6-position of the phenol residue may be the same or different and are selected from the group consisting of branched C₁ to C₁₂ alkyl, R₂ and R₃ having the meaning as given before, and W is selected from C₁ to C₁₂ alkyl, C₁ to C₁₂ alkoxy, C₁ to C₁₂ alkyl carboxylate or C₁ to C₁₂ alkyl substituted by another group of the formula HO—(R₁R₂R₃R₄Phenyl)-, wherein R₁ to R₄ have the meaning as indicated before.

5. The stabilized polymer composition of claim 1, wherein the sulphur-containing compound of general formula (III):
R₈—(S)ₓ—R₉ (III)
is selected from Di(C₁-C₂₀)alkyl-(S)ₓ-di-carboxylate wherein the carboxylic acid is selected from C₁ to C₁₂ alkyl carboxylic acids.

6. The stabilized polymer composition of claim 1, wherein the sterically hindered phenolic compound is selected from the group consisting of 2,6-Di-tert-butyl-4-methyl phenol; Pentaerythrityl-tetrakis(3-(3′,5′-di-tert-butyl-4-hydroxyphenyl)-propionate; Octadecyl 3-(3′,5′-di-tert-butyl-4-hydroxyphenyl)propionate; 1,3,5-Trimethyl-2,4,6-tris-(3,5-di-tert-butyl-4-hydroxyphenyl)benzene; 2,2′-Thiodiethylene-bis-(3,5-di-tert-butyl-4-hydroxyphenyl)-propionate; Calcium-(3,5-di-tert-butyl-4-hydroxy benzylmonoethylphosphonate); 1,3,5-Tris(3′,5′-di-tert-butyl-4′-hydroxybenzyl)-isocyanurate; Bis-(3,3-bis-(4′-hydroxy-3′-tert-butylphenyl) butanoic acid)-glycolester; 4,4′-Thiobis(2-tert-butyl-5-methylphenol); 2,2′-Methylene-bis(6-(1-methyl-cyclohexyl)para-cresol); N,N′-hexamethylene bis(3,5-di-tertButyl-4-hydroxy hydrocinnamamide; 2,5,7,8-Tetramethyl-2(4′,8′,12′-trimethyltridecyl)chroman-6-ol; 2,2′-Ethylidenebis(4,6-di-tert-butylphenol); 1,1,3-Tris(2-methyl-4-hydroxy-5-tert-butylphenyl)butane; 1,3,5-Tris(4-tert-butyl-3-hydroxy-2,6-dimethylbenzyl)-1,3,5-triazine-2,4,6-(1H,3H,5H)-trione; 3,9-bis(1,1-dimethyl-2-(beta-(3-tert-butyl-4-hydroxy-5-methylphenyl)propionyloxy)ethyl)-2,4,8,10-tetraoxaspiro(5,5)undecane; 1,6-Hexanediyl-bis(3,5-bis(1,1-dimethylethyl)-4-hydroxybenzene-propaonate); 2,6-Di-tert-butyl-4-nonylphenol; 3,5-Di-tert-butyl-4-hydroxyhydrocinnamic acid trimester with 1,3,5-tris(2-hydroxyethyl)-s-triazine-2,4,6(1H,3H,5H)-trione; 4,4′-Butylidenebis(6-tertButyl-3-methylphenol); 2,2′-Methylene bis(4-methyl-6-tert-butylphenol); 2,2-Bis(4-(2-(3,5-di-t-butyl-4-hydroxyhydrocinnamoyloxy))ethoxyphenyl))propane; Triethyleneglycol-bis-(3-tert-butyl-4-hydroxy-5 methylphenyl) propionate; Benzenepropanoic acid, 3,5-bis(1,1-dimethylethyl)-4-hydroxy-, C₁₃-C₁₅-branched and linear alkyl esters; 6,6′-Di-tert-butyl-2,2′-thiodi-p-cresol; Diethyl((3,5-bis(1,1-dimethylethyl)-4-hydroxyphenyl)methyl)phosphonate; 4,6-Bis(octylthiomethyl)o-cresol; Benzenepropanoic acid, 3,5-bis(1,1-dimethylethyl)4-hydroxy-, C₇-C₉-branched and linear alkyl esters; 1,1,3-Tris[2-methyl-4-[3-(3,5-di-t-butyl-4-hydroxyphenyl)propionyloxy]-5-t-butylphenyl]butane; and Butylated reaction product of p-cresol and dicyclopentadiene.

7. The stabilized polymer composition of claim 1, wherein the sulphur-containing compound is selected from the group consisting of Di-stearyl-thio-di-propionate; Di-palmityl/stearyl-thio-di-propionate; Di-lauryl-thio-di-propionate; Di-tridecyl-thio-di-propionate; Di-myristyl-thio-di-propionate; Pentaerythritol octyl thiodipropionate; Lauryl-stearyl-thio-di-propionate; Di-octadecyl-disulphide; Di-tert-dodecyl-disulphide and Pentaerythritol-tetrakis-(3-laurylthiopropionate).

8. The stabilized polymer composition of claim 1, wherein the sterically hindered phenolic compound is selected from the group consisting of Pentaerythrityl-tetrakis(3-(3′,5′-di-tert-butyl-4hydroxypheyl)-propionate; Octadecyl 3-(3′,5′-di-tert-butyl-4-hydroxyphenyl)propionate; 1,3,5-Trimethyl-2,4,6-tris-(3,5-di-tert-butyl-4-hydroxyphenyl) benzene; 1,3,5-Tris(3′,5′-di-tert-butyl-4′-hydroxybenzyl)isocyanurate; Bis-(3,3-bis-(4′-hydroxy-3′-tert-butylphenyl)butanoic acid)-glycolester; and 3,9-Bis(1,1-dimethyl-2-(beta-(3-tert-butyl-4-hydroxy-5-methylphenyl)propionyloxy)ethyl)-2,4,8,10-tetraoxaspiro(5,5)undecane.

9. The stabilized polymer composition of claim 1, wherein the sulphur-containing compound is Di-stearyl-thio-di-propionate or Di-tert-dodecyl-disulphide.

10. The stabilized polymer composition of claim 1, wherein
(a) the sterically hindered phenolic compound is 1,3,5Tris(4-tert-butyl-3-hydroxy-2,6-dimethylbenzyl)-1,3,5triazine-2,4,6-(1H,3H,5H)-trione or pentaerythrityltetrakis(3-(3′,5′-di-tert-butyl-4-hydroxyphenyl)-propionate;
(b) the phosphite compound is bis(2,4-dicumylphenyl)pentaerythritol diphosphite; and
(c) the sulphur-containing compound is Di-stearyl-thio-di-propionate.

11. The stabilized polymer composition of claim 1, wherein said composition further comprises metal deactivators and/or UV-stabilizers.

12. The stabilized polymer composition of claim 11, wherein said UV-stabilizers are sterically hindered amines.

13. The stabilized polymer composition of claim 1, wherein said polyolefin is a homo-or copolymer of polyethylene, polypropylene and polybutadiene.

14. Use of the antioxidant composition as defined in claim 1 for reducing degradation of a polyolefin material during processing and end use of said polyolefin material.

15. The use of claim 14, wherein the long term thermal stability of the polyolefin material is increased.

16. Method for producing a polyolefin article having an improved long term thermal stability against ageing by radical degradation processes comprising the steps of:
(a) providing an unstabilized base polyolefin material;
(b) adding to said base polyolefin material the antioxidant composition as defined in claim 1;
(c) converting the composition obtained in step (b) in a melt-forming process; and
(d) confectioning the polyolefin material obtained in step (c).

17. The method of claim 16 further comprising adding other stabilizers and/or modifiers before the converting step c).

18. The method of claim 16, wherein the converting step c) includes injection molding, blow-molding, rotational molding and extrusion.

19. The method of claim 16, wherein the confectioning step d) includes cutting, lamination and/or welding.

20. Polyolefin article having an increased long term ageing stability obtained by the method of claim 16.

21. The stabilized polymer composition of claim 1, wherein the branched alkyl having 1 to 12 carbon atoms is selected from tert-butyl, iso-propyl, cyclohexyl, cyclopentyl, and adamantyl.

22. The stabilized polymer composition of claim 1, wherein R₈ and R₉ are optionally substituted with C₁-C₁₂ alkyl ester carboxylates.

23. The stabilized polymer composition of claim 4, wherein the branched alkyl having 1 to 12 carbon atoms is selected from tert-butyl, iso-propyl, cyclohexyl, cyclopentyl, and adamantyl.

24. The method of claim 17, wherein the converting step c) includes injection molding, blow-molding, rotational molding and extrusion.

25. The method of claim 17, wherein the confectioning step d) includes cutting, lamination and/or welding.

26. The method of claim 18, wherein the confectioning step d) includes cutting, lamination and/or welding.

27. Polyolefin article having an increased long term ageing stability obtained by the method of claim 17.

28. Polyolefin article having an increased long term ageing stability obtained by the method of claim 18.

29. Polyolefin article having an increased long term ageing stability obtained by the method of claim 19.
